(19) United States
(12) Patent Application Publication
(10) Pub. No.: US 2010/0013114 A1
(43) Pub. Date: Jan. 21, 2010

(54) METHOD OF FORMING

(76) Inventors: Roderick William Jonathan Bowers, Bellshill (GB); Neil Bonnette Graham, Bellshill (GB); Abdul Rashid, Bellshill (GB)

Correspondence Address: K&L Gates LLP, STATE STREET FINANCIAL CENTER, One Lincoln Street, BOSTON, MA, 02111-2950, US

(21) Appl. No.: 12/282,235

(22) PCT Filed: Mar. 12, 2007
(86) PCT No.: PCT/GB2007/000870

§ 371 Date: Jun. 1, 2009

(30) Foreign Application Priority Data
Mar. 10, 2006 (GB) 0604845.8

(51) Int. Cl. B29D 11/00

(52) U.S. Cl. 264/2.1; 264/1.1

(57) ABSTRACT

The present invention relates to a method of using non-macrogelled polymer-solvent combinations to form devices, in particular medical devices and/or cosmetic devices, more specifically contact lenses. The method of using polymer solvent combinations is suitable for forming useful 3D dimensionally stable structures which may include curved surfaces, which may be significantly different to those curved surfaces achieved by using simple meniscus effects.

The present invention relates to the use of non-macrogelled polymer-solvent combinations to form devices, in particular a method of using non-macrogelled polymer solvent combinations suitable for forming useful 3D dimensionally stable structures which may include curved surfaces, which may be significantly different to those curved surfaces achieved by using simple meniscus effects. Further, the present invention relates to devices, particularly medical device and/or cosmetic devices, for example medical and/or cosmetic devices formed by said methods of the invention.

### BACKGROUND

Generally, hydrogels used in the production of devices, for example contact lenses, are formed by polymerisation of a monomer or monomer mixture, which may contain polyfunctional vinyl crosslinkers, for example ethylene glycol dimethacrylate or the like. However, as these polymer compositions are macro covalently cross-linked and do not flow, they must be moulded by reaction injection moulding (RIM) or related “polymerisation in place” (PIP) processes. Typically these techniques require mould surfaces or other mechanical means to provide curvature to surfaces of the produced device. These “polymerisation in place” processes are relatively slow and expensive to perform, often result in intramould lens shrinkage problems and are not best suited to high volume low cost manufacturing techniques, for example as required in the production of a contact lens for the correction of visual defects such as myopia, hypermetropia, astigmatism or presbyopia.

In view of the economic and quality limitations of current RIM manufacturing techniques to provide high volume low cost polymeric devices, such as contact lenses and the like, it would be advantageous to provide alternative methods of forming polymeric devices, which provide reduced cost of goods and improved quality and functionality, in particular polymeric devices comprising at least one curved surface, for example, but not limited to, vision correction devices in particular, a contact lens, corneal onlay or corneal inlay.

### SUMMARY OF THE INVENTION

The inventors have surprisingly determined a method of forming a three dimensionally stable device with a polymeric structure using a fluid solution comprising a non-macrogelled polymer provided within a dispersing agent, wherein said fluid solution is applied to a mould, and gelled. Advantageously, said devices may be provided with precise surface and structural morphologies. Such a method is highly desirable due to the low economic production cost and high level of repeatable accuracy achievable when forming the devices. Advantageously, the method of the present invention may minimise shrinkage of the polymer device in the mould, (mould shrinkage) during formation of the device.

According to the first aspect of the present invention there is provided a method of forming a device having a polymeric structure, wherein said device has at least one curved surface, comprising the steps;
providing a fluid solution, comprising a non-macrogelled polymer and a dispersion agent,
applying the fluid solution to at least one receiving surface of a mould, the receiving surface(s) of the mould being shaped to receive said fluid solution,
allowing the formation of the device, by gelation by at least one step selected from;
   i) removing at least part of the dispersion agent from the fluid solution,
   ii) modulating the temperature of the fluid solution,
   iii) modulating at least one of the shear and vibrational state of the fluid solution,
   iv) modulating the pH of the fluid solution, and
   v) adding a non solvent for the non-macrogelled polymer which is a swelling agent for the non-macrogelled polymer.

In embodiments of the methods of the invention, the step of removing at least part of the dispersion agent from the fluid solution, employs exchange of the dispersion agent with a different solvent for the polymer.

Suitably the curved surface produced can be a refractive curved surface, wherein the polymeric device allows for the bending of light. In particular embodiments the curved surface is convex. In alternative embodiments the curved surface is concave. In particular embodiments, the curvature is sufficient to allow the device to be useful for correction of visual defects.

In embodiments of the method, the fluid solution is provided between at least two moulds or mould surfaces, wherein at least a first mould surface has at least one fluid solution receiving surface, and at least a second mould partially or completely contacts a surface of the fluid solution. In a particular embodiment, a male and female mould surface can be provided wherein the female mould surface is shaped to provide a convex surface on the device, for example a front surface of a contact lens, and the male mould surface is shaped to provide a concave surface on the device, for example a back surface of a contact lens wherein, in use of the lens, said back surface is typically that which is in contact with the eye.

In alternative embodiments of the method the mould comprises a mould shaped such that at least one surface of the fluid solution is not in contact with a mould surface (a non-mould contact surface of the fluid solution). In particular embodiments, the mould can be an open mould such that a surface of the fluid solution is not in contact with a mould surface (a non-mould contact surface of the fluid solution) and said non-mould contact surface of the fluid solution is completely exposed to the surrounding environment. However, as will be appreciated, in other embodiments of the method, a mould can be provided wherein said mould is shaped such that at least one surface of the fluid solution is not in contact with a mould surface, but said non-mould contact surface of the fluid solution is completely or partially covered or enclosed by suitable means, for example a mould cover, wherein said means does not contact the non-mould contact surface of the fluid solution, but completely or partially minimises exposure of the fluid solution to the surrounding environment.

In particular embodiments of the method, to provide a device wherein said device has at least one curved surface, said method comprises the steps;
providing a fluid solution, comprising a non-macrogelled polymer and a dispersion agent,
applying the fluid solution to a receiving surface of a mould, the receiving surface of the mould being shaped to receive said fluid solution, such that the fluid solution has at least one non-mould contact surface not in contact with a mould,
allowing the formation of the device, by gelation and forming a curved surface of at least one non-mould contact surface of the fluid solution by at least one step selected from;
   i) removing at least part of the dispersion agent from the fluid solution,
   ii) modulating the temperature of the fluid solution,
   iii) modulating at least one of the shear and vibrational state of the fluid solution,
   iv) modulating the pH of the fluid solution, and
   v) adding a non solvent for the non-macrogelled polymer which is a swelling agent for the non-macrogelled polymer.

In particular embodiments the curvature of the device may be further modulated by at least one of:
i) applying centrifugal force to the fluid solution, and
ii) modulating air pressure or air flow at a non-mould contact surface of the fluid solution.

In embodiments of the step of applying centrifugal force to the fluid solution, the mould receiving surface may be spun and/or a means for applying the fluid solution to the mould surface may be spun.

In particular embodiments of said method to provide a device with at least one curved surface the fluid solution is provided to a receiving surface of an open mould.

The optional step of removing at least part of the dispersion agent, for example a solvent may occur passively by evaporation or exchange; or actively through use of centrifugal force, pH change, temperature change, for example elevation, and accelerated drying of the fluid solution.

In embodiments of the method the polymeric device may be formed by a temperature change (usually cooling) or by cessation of sheer, vibration or spinning of the fluid solution.

The method of the present invention provides for the use of fluid solution comprising non-macrogelled polymer and a dispersion agent, without any necessary reaction to cause significant chemical bond formation, applied to a mould surface of a mould, to provide a 3D shaped polymeric device which can retain its 3D shape under appropriate conditions, wherein said polymeric device has at least one curved surface. Suitably the fluid solution may be provided to a mould such that the fluid solution has at least one non-mould contact surface not in contact with a mould and said non-mould contact surface forms a curved surface when the fluid solution forms a gelled polymer. The method of the present invention is advantageous as it provides an alternative methodology to manufacture curved polymeric devices and in particular embodiments further removes the need of a mould surface to provide a curved surface. Advantageously, the curved surface provided on gelling may be of greater curvature than that provided by meniscus effects alone. As will be appreciated, the device having a polymeric structure, may be provided onto a non-polymeric substrate or material.

In one embodiment of the method, the fluid solution comprising non-macrogelled polymer and a dispersion agent can be caused to gel by addition (rather than removal) of a non solvent for the non-macrogelled polymer which is also a swelling agent for the non-macrogelled polymer. The said non solvent may be added as liquid or vapour.

Suitably in an embodiment of the method comprising the step of modulating the temperature of the fluid solution, a heated fluid solution comprising non-macrogelled polymer and a dispersion agent may be provided into a mould such that when the non-macrogelled polymer and a dispersion agent cools in the mould a polymeric device may be provided which can retain its 3D shape. In particular embodiments, a heated fluid solution comprising non-macrogelled polymer and a dispersion agent may be provided into an open mould such that said fluid has a non-mould contact surface and said non-mould contact surface. Additionally, the curvature of said non-mould contact surface may be modified by spinning of the fluid solution during gelation.

In particular embodiments, a solution under shearing (stirred) conditions may be provided into or onto a stationary or spinning mould and gelled to a 3D shape-retaining structure by reducing or minimising at least one of the shear and vibrational state of the fluid solution.

Suitably polymeric devices of the invention can, by reversible physical molecular bonds or micro/nano phase separation or structure formation effects, create a macro-structure which has physical strength to prevent flow under its own weight, under low shear conditions, combined with the ability to swell with aqueous solution or any other hydrophilic non-solvent for the polymer and still not flow under its own weight and yet be soluble in non-aqueous hydrophilic solvent for the polymer.

The formation of the polymeric device is believed to be similar to crossing a phase boundary and allows a product to be formed which is soluble in a predominantly non aqueous solvent, but which must, over a wide concentration range be insoluble, but swellable, in water or aqueous solution.

The gelation process is complex, but may be considered as being caused by a change in the “solvent” relationship of the solvent or dispersion agent to the various different, but covalently joined molecular parts of the non-macrogelled polymer. This may be guided by the well known concept of “solubility” parameter. Thus, the non-macrogelled polymer contains (conceptually) multiple domains having two or more different solubility parameters. For two such different domains in a non-macrogelled polymer it is possible to envisage three different states of polymer interaction:
(a) The dispersion agent is a good solvent for both domains. The result is a solution of the non-macrogelled polymer.
(b) The dispersion agent is a good solvent for one of the domains but precipitates the other to provide inter-molecular phase separated domains. This is a swollen gel structure which is desired.
(c) The dispersion agent is a poor (precipitating) solvent for both domains. This provides an insoluble and non-swollen solid.

Solvents are envisaged as being able to change from class (a)→(b)→(c) with change in solvent composition, temperature, pH or shear of the fluid solution. As will be understood by those of skill in the art, the boundaries between (a)/(b)/(c) are also broad in such complex molecular polymer compositions.

The desirable product gels of this invention are in group (b). Individual solvents can be in classes (a), (b) or (c) for a particular non-macrogelled polymer composition. It is possible to design solvent mixtures from solvents or non-solvents of “averaged” values of solubility parameter which desirably match that required to dissolve the non-macrogelled polymer. If the solvent mixture comprises a volatile “dissolving solvent” of class (a) and a lesser volatile solvent of class (b), the removal of the volatile dissolving solvent by evaporation or exchange or partial exchange with a solvent of either class (b) or (c) will cause the fluid solution to slowly change from a solution (of both segment types) to a swollen gel (only one segment suited to the mixed solvent) and finally if the solvent is completely exchanged for a class (c) solvent there will be formed a non-swollen precipitated polymer which is not a desirable outcome for making the swollen products of this invention.

Preferably, water is the class (b) solvent for the hydrogels of interest so exchange of a class (a) solvent by water causes the composition to gel to form the desired dimensionally stable “gel”.

Solubility parameter values for solvents with polymers vary with temperature due to significantly different expansion coefficients of low molecular weight solvents and polymers. A mixing/demixing temperature is commonly found as an “upper” or “lower” temperature effect. This demixing can promote the necessary phase separation and gelation where the solvent/polymer relationship starts in condition (a) and finally after change of solvent composition by any described means, by temperature change or by shear or vibration (such as sonication) can allow the solvent/polymer relation to change to that of group (b) forming a swellable gel structure.

In the present invention, hydrogels are materials which swell but do not dissolve in water making water a desirable solvent of class (b). However, typically water alone is not an appropriate “dissolving” solvent for hydrogels and thus may be used in combination with class (a) solvents in the method of the invention.

Preferable solvents for use as a dispersion agent are those which mix with and dissolve in water and which alone or as mixtures act as good dissolving or dispersion agents for a suitable non-macrogelled potentially interacting polymer. Preferred solvents produce with the said polymer, under suitable conditions of temperature, shear or vibration, a solution of class (a). This solution of class type (a) will be capable of converting to a class type (b) by composition change (preferably with water), by temperature change with or without compositional change or by a change of shear or vibrational state resulting in a composition of class (b). The change from condition (a) to condition (b) is time dependent and allows for the formation of the appropriately shaped (curved) non-mould contact surface. The time factor allowed for the shaping in the differently described procedures for operating the process allow surfaces of different shapes and curvatures to be formed repeatably and reproducibly. The curvature may be formed by the ‘freezing’ of a 3D shape by the gelation process of proceeding across the boundary between class (a) and (b).

In embodiments of the method utilising an open mould, the mould surface of the open mould may determine the 3D shape of a significant part of the polymeric device's final surface and volume. The shape of the remaining surface(s) of the polymeric device may be formed by part of the method resulting in the dispersion agent being removed, for example, by evaporation or solvent extraction.

Removal or appropriate change of the composition, temperature or shear condition of the dispersion agent causes the fluid solution, by gelation, to form a device of stable configuration by the formation of an essentially non flowing (under low shear) material by the formation of physical, but not covalent bonding, from a fluid material which may flow at a significant rate at room temperature.

The inventors have surprisingly determined that using the method of the present invention, when the fluid solution of polymer is applied to a mould surface and at least one surface of the fluid solution is not in contact with a mould surface (non-mould contact surface), said non-mould contact surface of the fluid solution forms a curved surface on removal or exchange of the dispersion agent. Advantageously, the method of the present invention may be used to provide polymeric devices which have precisely formed reproducible curved surface morphology on at least one surface. In contrast to existing methods, the present method does not require the presence of both front and back (male and female) mould sections, but provides for the forming of a suitable back surface without a back mould.

The formation of such a non-mould curved surface is not simply attributable to a meniscus effect as with low molecular weight fluids. Although not wishing to be bound by theory, the inventors believe that in one mode of action, the formation of a gel structure which forms the basic structure of a final product a ‘skin’ formed by the diffusive loss of solvent from the surface, is initially formed on the non-mould contact surface of the fluid solution or of polymer which will form the device while the remainder of the solution stays fluid. This establishes a thin film of strong high concentration and gelled skin causing a very thin polymer concentration gradient from very high and gelled at the outer surface to liquid and low concentration a short distance away in the non skin-bulk of the material.

The degree of perfection of the skin is considered to depend on the degree of elasticity and strength of the pseudoplastic polymer. The skin is considered to form more quickly with thixotropy or pseudo-plasticity. The thickness of the skin is considered to depend on rheology, surface shear, surface tension properties, pseudoplasticity of the polymer and exposure to a non-solvent or swelling only agent for the polymer, particularly water in the liquid or gas state.

On addition of aqueous solution or vapour, for example, but not limited to water, to the fluid solution, the aqueous solution or vapour is initially held above the skin, but rapidly diffuses across the film and as it mixes with non-gelled liquid, causes it to gel until progressively the entire polymeric device, for example a lens, is gelled. This device forms a reproducible outer curvature and degree of swelling in e.g. pure water.

The final product and molecular network has a particular degree of swelling in water even though it might have been formed initially by a different solvent mixture (water plus ethanol for example) and had a different degree of swelling in the mixed solvents

The properties of the polymeric device can be reproducibly determined by selecting a particular average polymer concentration after a particular weight (proportion) of solvent has been lost by evaporation. A device, for example a lens with a reproducible curvature may thus be established.

For a static system, given the mould and polymer composition, the main factor to be controlled is simply the weight or volume to which the solution is evaporated, ready for the addition of water.

The shape of the polymeric device may be fixed by the contact of the polymeric device with a swelling agent which is a non-solvent, particularly water under certain concentrations. The skin of the polymeric device is considered to prevent fluids draining further and attains a wide curvature of the surface, i.e. one which cannot be formed simply by meniscus effects.

The one or more curved surface(s) may be produced with suitable precision and a degree of curvature required for medical device formation and application, for example, but not limited to, the formation of contact lenses.

Suitably the mould surface of a mould is a mould surface suitable for forming contact lenses for the correction of visual defects such as myopia, hypermetropia, astigmatism or presbyopia or other ocular medical devices. In particular embodiments the mould can include two mould surfaces to form the back and front surface of a contact lens respectively. In alternative embodiments, the mould can provide the fluid solution with a non-mould contact surface which may be suitably curved using the methods of the present invention without mechanical assistance.

In embodiments of the method to provide contact lenses, the open mould surface of a mould, is adapted to provide a suitable shaped front surface of a contact lens, wherein in use said front surface is that not in contact with the eye. The curvature of the non-mould contact surface of a polymeric device formed in said mould by the method of the present invention is suitably shaped for placement of said polymeric device on the eye such that the non-contact mould surface is in contact with the surface of the eye. The mould surface should afford a lens which has appropriate physical dimensions: diameter, base curvature of radius, centre thickness and edge thickness, to fit the cornea. Other moulds should afford devices which appropriate dimensions for application and use.

By using the thermoplastic properties of the polymer in the method, a curved surface may be formed both with and without mechanical assistance for example with or without spinning of the mould or spray head or both, or the use of a second mould surface. As will be appreciated, the mould surface to which the fluid solution is applied may be a curved mould surface.

Optionally, the method of the present invention may further include an additional step of further polymerisation, spinning, or other mechanical assistance means as used in current lens and refractive device manufacturing techniques.

In particular embodiments, a mould surface used in the method of the present invention may be provided by a base of a receptacle wherein said receptacle further comprises side walls to mechanically restrain the polymer solution on the mould surface.

In the step of applying the fluid solution to a mould surface of a mould, wherein the mould is a receptacle, the receptacle may be completely or partially filled with the fluid solution of polymer prior to the gelation step, for example of removing the dispersion agent. In particular embodiments of the method the mould surface of the receptacle may be curved.

In embodiments wherein the fluid solution of polymer is applied into a receptacle, the upper surface of the fluid solution is typically that not in contact with a mould surface and said upper surface of the fluid solution can form a curved surface. As will be appreciated, in embodiments wherein a mould surface is curved, for example wherein the mould surface is formed by the base of a receptacle and the base is curved, the upper surface of the fluid solution may provide the formed device with a non-mould contact surface with a different curvature to that of the surface of the formed device in contact with a mould surface.

Thus, using such embodiments of the method of the present invention, a three dimensional polymeric device, for example a prosthesis, having a first curved surface provided by a mould and a second curved surface provided with or without mechanical assistance may be provided.

Non Macrogelled Polymer

Said non-macrogelled polymer may be a single polymer or a mixture of polymers which possess structural features which by modulation of solvent, temperature, pH or shear of a fluid solution of said polymer in a dispersing agent, promote reversible interchain bonding, such as microscopic phase separation, hydrogen bonding, polar bonding, π bonding, hydrophobic bonding, electrostatic bonding, or ionic bonding, but which are not covalently bound to each other. This contrasts conventional macrogelled polymers wherein the polymer chains are covalently bound together. Suitably said non-macrogelled polymers are synthetic polymers. Suitably, said polymers do not include carbohydrate, or protein.

Suitably said non-macrogelled polymer can be a suitable polymer as described in WO 91/02763, WO94/22934, or WO2004/020495.

In particular embodiments the non-macrogelled polymer can be a copolymer of units of polyethylene oxide wherein said polymer includes moieties which provide for physical intermolecular and intramolecular chain interactions, associations and bonding. Suitably said interactions may be non-directional.

Suitably said polymer may optionally incorporate additives or active agents.

As will be understood by those of skill in the art, whilst non-macrogelled polymers useful in the invention may comprise internally cross-linked discrete microgel or nanogel domains, in contrast to conventional chemically cross-linked macrogelled polymer, the polymer useful in the present invention will be soluble in solvent.

Suitably said non-macrogelled polymer may be polyethylene oxide based co-polymers with chain extension; or block/linear/graft/branched co-polymers with other moieties which promote intermolecular and intramolecular chain interactions, associations or bonding and provide the property of the formed material to swell in water without significant dissolution to give water insoluble swollen gels with significant physical strength.

The non-macrogelled polymer may be chain extended or block/linear/graft/branched co-polymers of polyethylene oxide with other moieties which have a potential to induce microphase separation, for example, but not limited to, polystyrene, polyhydrocarbon, polyoxyalkyleneoxide, polyalkyleneoxide, polyester, polyamide, polyurethane, polyhydroxyalkyl methacrylate, polyacrylic acid, polymethacrylic acid, polyalkyl methacrylate, polyvinylpyrrolidine, polyalkylacrylate, polyhydroxy alkylacrylate, polyacrylamide, polymethacrylamide, polyureas, polypropylene oxide and polyurethaneurea.

Preferably, the non macrogelled polymers, are for example but not limited to, hydrogels. These hydrogels may comprise nanogel or microgel particles which are soluble in solvents, but internally crosslinked in discrete nano or microdomains. The use of such polymers as nano or microgel dispersions allows high molecular weight polymers with varying levels of physical and mechanical properties in both the dry and water swollen conditions to be utilised without the generation of high solution viscosities.

As well as preparation by non-radical initiation, such polymers can be made using free radical chain growth methods involving initiation by radical generating species such as peroxides, hydroperoxides, azo compounds and optionally with the aid of various forms of irradiation as is well known in the art. It is known to prepare these materials in solution or after completion of the free radical polymerisation to prepare them as soluble powders which can be blended with the non-macrogel polymer solutions, without causing damage to the polyethylene glycol materials from free radicals.

Other hydrogel-forming polymers may comprise polymers or copolymers of acrylates or methacrylates including alkyl acrylate, hydroxyl alkylacrylate, aryl acrylate, alkacrylate, aryl methacrylate, hydroxyl alkyl methacrylate, alkyl methacrylate, acrylic acid, methacrylic acid, acrylamide, alkacrylamide, n-vinyl lactam, ethylenically unsaturated zwitterions (where typically the centre of permanent positive charge is provided by a quaternary nitrogen atom), or silicone. Peptides, proteins, natural poly acids, polyamines, polyamide, polysaccharide and starches, polyethylene glycols or copolymers may be suitably provided to said hydrogel-forming polymers. Suitably, hydrogel polymers can be prepared as micro- or nanogels in organic solvents or mixtures and used in the method of the invention. These and other suitable moieties for use (e.g. polyvinyl alcohol, polyvinylether) would be well known to those skilled in the art.

In a particular embodiment of the method the percentage of polymer in the fluid solution may be in the range 2% to 90%, for example 2%, 4%, 6%, 8%, 10%, 12%, 20%, 25%, 30%, 40%, 50%, 60%, 70%, 80%, 90%.

Linear homopolymer or block co-polymers of PEG may also be blended with branched or nanoparticles of hydrogel forming polymers to provide compositions which could not be made by direct polymerisation.

As will be understood by those skilled in the art, at concentrations of the polymer in solution above a particular value (which may be a different value for every polymer system), the bulk flow of the material can become pseudo plastic. A pseudo plastic polymer is one that under small deformations (stress) behaves as an elastic solid which retains its configuration.

Polymer(s) which exhibit solution properties which are perfectly free flowing at dilute solutions (5-10%) but transform into a pseudoplastic gel which cover compositions with a wide resistance to flow will normally possess structural features which promote solvent, temperature, pH or shear reversible interchain bonding, such as microscopic phase separation, hydrogen bonding, polar bonding, π bonding, hydrophobic bonding, electrostatic bonding or ionic bonding. For example, polyethylene oxide-based microgels made by reaction with a polyisocyanate are believed in certain configurations to comprise a:
hydrophobic core (composed for example in the case of a polyurethane primarily of aliphatic or aromatic moieties and polyol), and
hydrophilic loops or side chains extending therefrom formed of poly(ethylene) oxide or poly(ethyleneoxide) co-polymers.

which will orient themselves according to the solvent environment (i.e. the morphology of the polymer will change depending on whether hydrophilic or hydrophobic solvents are used) and/or the temperatures used.

In an embodiment of the method, mixtures of polymers may be used by co-reaction or admixture to increase the preferred/advantageous properties of the device provided by the method. This solution approach allows mixtures of different compositions to be readily blended in solution to form systems with modified properties.

A polymer may be suitably selected such that the finally formed device is transparent. For example, for PEG polyurethaneurea formulations containing mono or poly functional amines, those utilising aromatic amines afford predominately transparent systems.

Alternatively, a polymer may be suitably selected such that the finally formed device is opaque. For example, for PEG polyurethaneurea formulations containing mono or poly functional amines, those utilising aliphatic amines afford predominately opaque systems.

In further alternatives, a polymer may be suitably selected such that the finally formed device is translucent, coloured, semi-transparent or transparent or which may change its transparency with temperature change.

Preferably, to form a contact lens using the method of the present invention the fluid solution of polymers selected are capable of forming hydrated lenses with equilibrium water contents of 5-95%.

In general opaque products are obtained from mixtures of two or more polymers or nano- or microgels.

Fluid Solution

The term fluid solution includes both fluid molecular solutions of non-macrogel polymer and fluid colloidal dispersions of non-macrogel polymer which are of dimensions not visible to the naked eye.

Fluid solutions encompass solutions which are dispersed as well as solvent solutions.

Preferably a fluid solution shows a large increase in viscosity with increasing concentration of the polymer as the solvent is lost. Preferably the increase in concentration leads, at high polymer concentration, to reversible physical bonding of the polymer to form a mass which can retain its 3D shape at the gelation point and at polymer concentrations increasingly above the gelation point. It is preferable in solvents which are compatible with water that the addition of water causes the physical bonding of the polymer and thus the macro-gelation like process to occur at a lower polymer concentration than in the absence of water.

Preferably the fluid solution of polymer may be capable of forming hydrated polymeric devices, for example contact lenses or intraocular lenses with equilibrium water contents between 2% to 95%, preferably 5% to 95%, more preferably 10-80%. The presence and concentration of hydrophilic domains which are incorporated into the polymer backbone or side chains govern the equilibrium content of the hydrated polymeric devices.

Dispersion Agent

Dispersion agents may include non volatile, or low volatile, non-polymerisable bulking agents or diluents, or water compatible bulking agents which are capable of forming hydrophilic bonds with polymer chains or a solvent or solvent mixture in which the non-macrogelled polymer is soluble. Dispersion agents may be exchanged partially or completely with buffer solution during hydration of the lens.

Suitably a solvent or solvent mixture for use in the method of the invention can have a closely similar solubility parameter and hydrogen bonding characteristics to that of the polymer used in the method.

The matching of the solubility parameters of a solvent or solvent mixture to a non-macrogelled polymer is well known in the art. As would be appreciated by those skilled in the art, it is necessary to take into account the components of solvent compatibility, cohesive energy density and polar/hydrogen bonding force components.

Suitably solvents or solvent mixtures which are pharmaceutically safe and non toxic can be used. Suitably, said solvents or solvent mixtures are safe for use in humans. Suitably said solvent or solvent mixture can be, and are preferably, water compatible. In particular embodiments the solvents or solvent mixtures can be selected from homologous mono or poly alcohols, mono or poly esters, mono or poly ketones, aliphatic or aromatic hydrocarbons, monoethers and polyethers (hydroxyl ended or alternatively those in which the hydroxyl group converted to ether or ester or protected in other ways as known to a person skilled in the art) cyclic monoether(s) or cyclic polyether(s) and the like.

As will be appreciated, the choice of solvent(s) may affect the physical properties and permeability of the formed device.

When the method of the present invention utilises solvent evaporation to remove the dispersion agent, a solvent or solvent mixture should have adequate volatility (i.e. appropriate to allow volatilisation under ambient or elevated conditions) to allow evaporation of the dispersion agent from the fluid solution such that the non-macrogelled polymers therein form a solid shape wherein said shape is formed over a reasonable commercial timescale (i.e. ranging from 5 seconds to 50 hours).

Suitably two or more solvents of high or low volatility may be used.

Preferably a solvent or solvent mixture may be water soluble such that the solvent(s) can be exchanged by water or any other non-solvent for the polymer, at any stage of the process, and the gelation via physical bonding of the polymer is thereby facilitated.

For example, in the case of a hydrophilic (water compatible) solvent such as ethanol, methanol, acetone, etc., any residual solvent remaining after gelation, may be minimised or eliminated if required by washing the polymeric device with saline solution or water after gelation.

Current lenses made by cast moulding suffer from hydrophobic memory effect. This is caused by the orientation of monomers during polymerisation such that interfacial tension with hydrophobic molding materials is minimised. During wear, the break up of the tear film on the anterior surface of the lens triggers this hydrophobic memory effect which in turn results in faster tear film break up times and decreased comfort for the contact lens wearer.

Advantageously the method of the present invention which utilises solvent may result beneficially in modified surface properties of a lens, for example, surface properties which maintain lens surface wettability. In an appropriate solvent, a solvent with solubility parameter characteristics close to those of the non-macrogelled polymer, liquid-polymer interactions expand the polymer coil from its unperturbed dimensions, in proportion to the extent of the interaction. Under these conditions as the solvent is allowed to evaporate off it may lead the polymer chains to provide a gel surface that maintains lens surface wettability.

In particular embodiments of the method, the use of a hydrophilic solvent provides polymer-hydrogen bonding solvent interactions, formed in preference to hydrophobic bonding interactions at the polymer solution-mold interface. As the solvent evaporates from between and within the polymer chains, hydrophilic polymer-solvent interactions will be replaced with hydrophilic polymer-polymer interactions thus generating a hydrophilic interface increasing surface wettability with the tear film.

This contrasts with RIM polymerized conventional hydrogels, which are cast against hydrophobic molds. Without the presence of hydrophilic solvents or the use of surfactants, these lenses strongly adhere to mould surfaces and even with the use of mould release agents, drying of the lens surface due to evaporation, results in exposure of the lens surface to hydrophobic (air) interface. This in turn triggers a rapid reorientation of the lens surface, mimicking conditions under which the lens was formed. This condition triggers the hydrophobic memory effect resulting in a sustained, non wetting interface, causing irreversible binding with tear components and a reduction in lens comfort.

Suitably a solvent(s) or swelling agent(s) may afford a change in polymer conformation and/or orientation in such a way that an opaque or translucent polymer composition may convert to an optically transparent form after solvent treatment. For example, some opaque or translucent PEG polyurethane formulations, when swelled in water to equilibrium, become transparent.

Conversely, a solvent(s) may afford a change in polymer conformation and/or orientation in such a way that a transparent polymer may convert to an opaque or translucent form after solvent treatment.

Suitably an agent, for example a solvent or solvent combination may be chosen which provides a fluid solution of polymer at an elevated temperature, for example at a temperature in the range 40-150 deg C. In a particular example, a polymer may be selected from polyamide or polyester, a solvent may be selected from methanol, ethanol, liquid poly(ethylene glycols), propylene glycols, methyl ethyl ketone and the like, and an elevated temperature in the range 40-150 deg C. may be used to dissolve the polymer to form a fluid solution.

In embodiments of the method in which the polymer only dissolves at an elevated temperature, the polymer fluid solutions may be applied to cold or heated moulds as appropriate.

Suitable polymer-solvent combinations may contain additives, active agents, etc. These combinations may be used in the method of the present invention to provide opaque, translucent, coloured, semi-transparent or transparent devices.

Application of Fluid Solution to Mould

The fluid solution of polymer may be applied to a mould surface using any suitable method. In particular embodiments of the method the fluid solution of polymer may be applied to a static or spinning mould surface by a static or spinning spray-head wherein said fluid solution of polymer is sprayed onto/into the mould.

In embodiments of the method wherein the fluid solution of polymer is applied to the mould by spraying, the fixation of the shape of the device by removal of dispersion agent from the fluid solution of polymer may occur due to evaporation of an agent partly in the spray of the fluid solution of polymer on the way to the mould surface and/or subsequently after the fluid solution contacts the mould surface and forms (by its solution rheology) a low-flowing or non-flowing shape and/or solvent exchange with non-solvent for a polymer. The shape of the formed polymer may gain strength and reduce its volume by the increasing concentration of the polymer resulting from the fixation by evaporation, solvent exchange and/or contact with a non-solvent for the polymer.

Optionally, in the step of applying the fluid solution to a mould surface, heat may or may not be provided to at least one of the fluid solution or the mould surface. The fluid solution and/or a mould surface may be heated to an elevated temperature in the range. Preferred temperatures are from 30-100 deg C. for both the mould and the fluid solution. Preferably, the temperatures should be below the boiling point of the solvents under the used conditions.

Suitably, in the step of removing at least part of the agent from the fluid solution, the agent may be removed by at least one of evaporation, solvent/agent exchange or a combination of said methods.

Evaporation completely or partially of the solvent/dispersion agent includes differential evaporation considerations (with associated polymer-polymer, polymer agent and/or polymer substrate interactions).

As the skilled person would appreciate, evaporation may be assisted by at least one of an increase in temperature, decrease of pressure and gas movement, or the use of gravimetric or centrifugal forces over the surface of the of polymer.

In a further embodiment, after partial evaporation or after application of gravitational/centrifugal force, the step of removing the remaining dispersion agent may be achieved by solvent exchange using a non-solvent or gelling agent for the polymer by immersion or by partial immersion or contact of the fluid solution of polymer in polymer non-dissolving but swelling liquids in the liquid or vapour state. This may provide for reaction of residual groups in the polymer.

Suitably, non-dissolving but swelling liquids may be water or a mixture of materials, for example water and another agent, for example saline.

Optionally, the method of the first aspect of the invention may further include a step of removing the formed polymeric device from the mould. Alternatively, the formed polymeric device may be retained in the mould.

This may be advantageous where, for example, the mould may be used as part of the final packaging of the formed polymeric device.

Optionally, the method of the present invention may further comprise a further step of exposing the formed polymeric device to water in a liquid or vapour state to provide further strength to the moulded device. This is advantageous as the polymer used in the method of the present invention has phase separation on a microscopic or submicroscopic scale which is energetically favoured in water as compared with other agents of lower cohesive energy density (or solubility parameter).

Suitably, the method of the present invention may provide three dimensional devices comprising at least one curved surface provided with a hemispherical or other desired edge profiles around the moulded device perimeter, for example the circumference.

Adjustment of the airflow over the evaporation surface intermittently during the period of evaporation may be used to alter the thickness of the edge of the device as desired. In addition, those skilled in the art may use the changes in the viscosity, volume and concentration of the polymer solution during the evaporation to alter the architecture, in particular the edge profile, of the polymer device.

In a particular embodiment, the method of the invention may include the steps of blowing air, which may be warmed, cooled or in a humid or dry state, or may contain water in the form of steam, at the fluid solution of polymer for initially around 5 seconds to 10 minutes, before reverting back to normal evaporation at ambient temperature, to generate a very thin edge on the polymeric device.

This is advantageous as desirable and/or acceptable edge profiles, which would conventionally require an extra step following typical moulding techniques, may be formed as part of the method of the present invention.

The precise edge profile formed depends on the surface interfacial energies between the polymer solution and the surface. The contact angle at the edge between the polymer solution and the construction material of the mould surface can vary from very low angles to angles greater than 90°. The obtained angle strongly influences the final shape of the edge in the finished formed lens. The contact angle is determined by the difference in surface energy between the material of the mould construction and the polymer solution (dispersion). Low surface energy surfaces, such as PTFE or polypropylene will normally provide high contact angles, whereas high surface energy surfaces such as stainless steel or glass provide low contact angles.

Optionally, the method of the present invention may further comprise the steps:
applying a further fluid solution of polymer to at least one surface of a previously applied fluid solution of polymer, wherein said surface is at least partially gelled,
gelling the further fluid solution wherein the method of gelation is at least one step selected from;
   i) removing at least part of the dispersion agent from the fluid solution,
   ii) modulating the temperature of the fluid solution,
   iii) modulating at least one of the shear and vibrational state of the fluid solution,
   iv) modulating the pH of the fluid solution, and
   v) adding a non solvent for the non-macrogelled polymer which is a swelling agent for the non-macrogelled polymer
forming at least a second layer of gelled polymer,

to form a layered polymeric device.

Suitably devices may be formed comprising multiple layers of polymer. Preferred devices comprising 2 to 12 layers may be provided. Alternatively devices 2 to 50, 2 to 100, 2 to greater than 100 layers may be formed.

In such embodiments the layers of fluid solution of polymer may be applied sequentially after the preceding layer has been partially or fully formed through the partial or full removal of the dispersion agent. Suitably layers of polymer, may be interspersed with layer of active agent or additive.

In embodiments of the method wherein the fluid solution of polymer, which may or may not include an active agent, is applied to the mould in sequential layers, the fluid solution may advantageously comprise an agent which is a thermodynamically good solvent or a mixture of solvent species for the fluid solution of polymer in any particular layer, or a non solvent for the polymer for the application of additive. In laying down such sequential layers it can be advantageous to utilise a mixture of a volatile good solvent and a less volatile poor or non-solvent so that the new layer formed after the volatile good solvent evaporates is left with a solvent which causes as little disruption as possible to the adjacent substrate layer.

Additives or Active Agents

Optionally, the method of the invention may comprise adding at least one of an additive or active agent to the fluid solution of polymer.

Suitably the polymeric devices formed by the method of the present invention can comprise active agent or additive.

Said active agent and/or additive may be a leachable agent or labile agent. Suitably, said active agent and/or additive can enhance or have a beneficial effect on bulk and mechanical properties, for example, modulus, oxygen or gas permeability of the polymeric device formed by the method. Suitably, said active agent can include at least one of a processing aid, a prophylactic and/or a therapeutic agent, (for example, but not limited to, an anti-prokaryotic agent, an anti-viral, an antimicrobial agent or an antifungal agent), a pharmaceutically acceptable surface modifying agent (such as, but not limited to, poly(ethyleneglycol), hydroxymethylcellulose, polyvinylalcohols, dipalmityl phosphatidyl choline and other phospholipids and their derivatives), a pharmaceutical agent, or a biologically active molecule for example, a growth factor, a cell binding component, a protein, a light and/or chemical and/or electrically responsive agent, a colourant, a fluorescing or phosphorescing agent, a UV absorber, a polarising agent, a photochromic agent or an antioxidant.

In the methods of the invention in which multiple layers of fluid solutions of polymer are applied to a mould surface, an active agent and/or additive may be incorporated into at least one layer of fluid solution of polymer applied to the mould surface.

This may be advantageous as delivery of an active agent may optimised, for example release of slowly diffusing high molecular weight agents and/or additives may be maintained by incorporation of these agents and/or additives into the outer layers applied to the mould surface, whilst rapidly diffusing low molecular weight agents may be included into interior layers (i.e. distant from the exterior surface) thereby controlling the duration of release. Suitably/similarly different concentrations of the same or different diffusates can be incorporated to generate the required release profile.

Indeed, in particular methods of the invention wherein the fluid solution or of polymer is applied to the mould surface as layers, an active agent and/or additive can be applied to a particular layer within a device and can remain within the device until activated by a particular solvent(s) and/or triggering agent(s) in, for example, blood or tears.

Advantageously an active agent may be at least one pharmaceutically acceptable surface modifying agent wherein such a pharmaceutically acceptable modifying agent reduces device interfacial tension with, for example, body fluids.

In particular embodiments of the method of the present invention, a surface modifying agent may be included into distinct layers of a polymeric device formed by the method of the present invention. In such embodiments the surface modifying agent may be slowly released or released by diffusion or through compression of the device (by mechanical, physical or other means) from particular layers of the device.

In particular embodiments, the active agent may be selected from at least one light and/or chemical and/or electrically responsive agent(s). These responsive agents may advantageously provide a device formed by the method with a sensor responsive to changes in pH, temperature, light, fluids or metabolites.

The inclusion of light and/or chemical and/or electrically responsive agent(s) in a polymeric device, may allow for the presence or absence of constituents of solutions surrounding the polymeric device to be determined. For example, in an embodiment of the method wherein the device provided is a contact lens, inclusion of light and/or chemical and/or electrically responsive agent(s) in the contact lens may allow for the presence or absence of constituents of the tear film to be determined. Suitably, testing for a particular constituent of the tear film may be similar to the testing of serum. For example, in a particular embodiment a contact lens formed by the method of the present invention may include an agent which is glucose responsive and can sense if glucose levels fall outwith a pre-determined range of glucose present in tears. This allows glucose levels in an individual to be continuously sampled and would avoid the need for blood to be provided to monitor the level of glucose. Alternatively or additionally, in patients who are distressed by the taking of blood samples, this provides an alternative procedure for said subjects.

Further Modification of a Surface of a Polymeric Device

In particular embodiments of the method of the present invention a further step of modifying at least one surface of the polymeric device, for example a contact lens, can be provided. Suitably, said further modification steps may include further moulding of a surface of a polymeric device, adhering an agent or additive to a surface of the polymeric device, etching a surface of the polymeric device, or punching a surface of a polymeric device.

In such embodiments a secondary mould can be used to mould or stamp a desired shape or pattern on a surface of a polymeric device formed by the method. The further moulding may provide a prism on at least one surface of the polymeric device. In one embodiment of the method wherein the polymeric device formed by the method is a contact lens, a prism can be stamped into the inner surface (surface which in use is in contact with the surface of the eye) of the lens. Further moulding of shapes or patterns onto a polymeric device may be advantageous to provide attractive back surface designs. For example, wherein the polymeric device formed by the method is a contact lens the contact lens may be provided with a high quality surface rugosity.

Optionally the method of the present invention may comprise the step of applying a second mould surface to a surface of the polymeric device such that the second mould surface may be in partial or complete contact with the curved surface and/or edge of the preformed polymeric device to incorporate an appropriate geometry onto said surface or edge, or to initiate the formation of an edge, the profile of which is formed by surface energy properties of the gelling polymer, air interface or mould materials. The second mould surface may or may not be heated.

Flash Removal

The formation of flashing (unwanted material around the edge of a polymeric device) is a major problem with conventional methods of manufacturing particular polymeric devices, for example contact lenses and intra ocular lenses. In both cases flashing must be removed in order to prevent significant damage to ocular tissue.

Whilst using particular methods to apply fluid solutions of polymer in solvent to a mould surface, for example, but not limited to, spray application, may minimise or completely remove the occurrence of flashing, the method of the present invention may further optionally include a step for removing flashing.

In such methods, flashing may be removed by treating the device with solvent, water or saline to remove flashing from the device. This method of flashing removal may advantageously provide suitable edge profiles on mono or bicurve devices.

In an embodiment of the method, the mould surface may include an overflow well around the perimeter of the mould surface to which the fluid solution of polymer is applied. Such a mould may be provided as a single mould system or a two part mould system. In such an embodiment, when an aliquot of the polymer solution is applied to the mould surface, a small volume may flow into the overflow. As the dispersion agent is removed from the fluid solution, for example by solvent evaporation, the polymeric device is formed and a thin edge on the device is formed at the boundary between the mould surface to which the fluid solution is applied and the overflow well. When the polymeric device is hydrated, this thin fragile material at the boundary swells more rapidly than the thicker mass of polymer forming the polymeric device and the mass of polymer in the overflow well, thereby putting stress on the boundary point. As a result, the formed polymeric device breaks away from the mass of polymer in the overflow well.

Suitably a fluid solution may be provided to the mould surface by dipping, spraying, immersing, etc. the whole or part of the mould and/or the device.

Demoulding of Polymeric Devices

It is advantageous if a device formed by the method of the present invention may be rapidly demoulded from the mould surface, as for example, the ability to decrease the time required to demould lenses from a mould surface significantly decreases the unit cost of goods.

Optionally the method may further comprise the step of pre-treating at least a mould surface with water swellable/swollen polymers and/or polymeric surfactants, water soluble greases or waxes or other mould release agents as known in the art. Suitably, where present, walls of a mould may also be pre-treated with water swellable/swollen polymers and/or polymeric surfactants, liquid release agents, water soluble greases or waxes or other mould release agents.

Suitable water swellable/swollen polymers and/or polymeric surfactants or mould-release agent may include poly(ethylene glycol) and its alkyl/aromatic ethers and esters and the like, poly propylene glycol, hydroxy methylcellulose, poly(vinyl alcohol) and or/other pharmaceutically acceptable surfactants. Other suitably hydrophilic polymers would be well known to those skilled in the art.

Suitably surfactants which include polymeric materials that have hydrophobic and hydrophilic portions include polyoxyethylene lauryl ethers, polyoxyethylene nonylphenyl ethers, polyoxyethylene sorbitan monooleates, polyoxyethylene sorbitan monolaurates, polyoxyethylene sorbitan monopalmitates, polyoxyethylene stearyl ethers, and their polyoxypropylene analogs.

Other surfactants found to be effective are the poloxamines, dioctyl sodium sulfo-succinate, and polyvinyl alcohol.

Alternatively, or additionally, Teflon spray may be applied to a demould surface.

Optionally the method of the first aspect of the invention may include the step or steps of hydrating, optionally with heat/cooling cycles, the polymeric device, for example a contact lens, to assist demoulding. Suitably cooling, cryogenic and/or mechanical assistance may also be used to assist demoulding in dry or wet state.

It is suggested that the hydration of the device causes the rapid swelling of the polymer which results in disruption and breakage of the bonds between the device and the mould surface. This accelerates the demoulding process. Optionally, the method may include adding a doping agent to the polymer wherein said doping agent rapidly swells on hydration of the polymeric device and assists in demoulding of the device.

Optionally the method of the present invention may include the step of solvating the device, for example a contact lens, to assist demoulding.

In particular embodiments the mould in which the device is formed may be used as a packaging part. This may eliminate the demoulding step prior to packaging and sale of the device.

Devices

The methods of the present invention may produce a range of polymeric devices. It is believed that the methods of the present invention will provide novel polymeric devices with improved characteristics.

Accordingly, a second aspect of the present invention provides a polymeric device produced by the method of the first aspect of the invention.

As stated above, the methods of the present invention allow the production of curved surfaces. Accordingly the methods of the first aspect of the invention may produce refractive device(s), such as, but not limited to, for example a contact lens, an optically perfect microscope cover, or a cover slip for magnifying field lenses.

In embodiments of the invention wherein the device is a refractive device, the refractive power of the device may be altered by altering the device thickness, the curvature of the back surface and/or the curvature and profile of the outer curved surface of the mould surface.

Parameters of the refractive device, for example refractive index, device thickness, device diameter and back curvature of radius may be altered by altering polymer formulation(s), polymer composition(s), solvent composition(s), polymer solvent concentration(s), rate of solvent evaporation and particle size(s). These parameters may be investigated and optimised by way of a series of empirically designed experiments involving polymer formulation(s), polymer composition(s), solvent composition(s), polymer solvent concentration(s), rate of solvent evaporation and particle size(s).

In particular embodiments of the refractive device wherein the device is a contact lens the thickness of the lens may be altered by changing the polymer concentration. Using fluid solutions or dispersions of polymer, device thickness and shape of the surface formed by removal of solvent, for example by evaporation, may be altered by varying solvent composition or concentration, rate of evaporation and particle size. There are two different sets of circumstances for the lens dimensions and topography:
1) the simple case is that of preparing a fully dried down lens
2) The much more complex case in which the lens is re-swollen into a contact lens for use with water or saline

In particular embodiments of the invention the device provided may be a drug delivery device.

Suitably in particular embodiments the device may be a medical device or a prosthesis. In specific embodiments, the devices may be a cosmetic device.

In particular embodiments the device may be selected from a contact lens; a therapeutic bandage lens; an underwater ocular system, a supra and intra corneal device; a phakic and aphakic intra ocular lens; a scleral buckling agent; a joint replacement device; a soft tissue reconstruction device; wound healing device; an antimicrobial plug or ring, a tissue engineering substrate, a scaffold for organ culture application, a neural growth surface, a neural growth tube, a urological device, a cardiovascular device, and a gynecological device.

In one embodiment the polymeric device may be a contact lens.

The application of multiple layers of solvated or dispersed polymer to a mould surface may be used to construct laminated devices wherein each layer has a similar or different function and property, for example, different layers may have different refractive properties. Using embodiments of the method of the present invention in which multiple layers of fluid solution or of polymer are applied to the mould surface, devices with a laminated structure may be formed. It is considered that the layered devices formed by such a method are novel.

Accordingly, a third aspect of the present invention provides a layered polymeric device produced using a method comprising the steps:
providing a fluid solution, comprising a non-macrogelled polymer and a dispersion agent,
applying the fluid solution to at least one receiving surface of a mould, the receiving surface(s) of the mould being shaped to receive said fluid solution,
allowing the formation of a layer of at least partially gelled fluid solution wherein said fluid solution is gelled by at least one step selected from;
   i) removing at least part of the dispersion agent from the fluid solution,
   ii) modulating the temperature of the fluid solution,
   iii) modulating at least one of the shear and vibrational state of the fluid solution,
   iv) modulating the pH of the fluid solution, and
   v) adding a non solvent for the non-macrogelled polymer which is a swelling agent for the non-macrogelled polymer
applying a further fluid solution of polymer to at least one surface of a previously applied fluid solution of polymer,
gelling the further fluid solution wherein the method of gelation is at least one step selected from;
   i) removing at least part of the dispersion agent from the fluid solution,
   ii) modulating the temperature of the fluid solution,
   iii) modulating at least one of the shear and vibrational state of the fluid solution,
   iv) modulating the pH of the fluid solution, and
   v) adding a non solvent for the non-macrogelled polymer which is a swelling agent for the non-macrogelled polymer forming at least a second layer of gelled polymer,

to form a layered polymeric device.

Embodiments of multilayered polymeric devices may comprise complex internal morphologies, topologies or rugosities.

Particular embodiments of multilayered polymeric devices may be drug delivery devices or sensors.

Embodiments of layered devices may be suitable for use in wound healing, nerve regeneration, tissue engineering scaffolds, corneal onlays and other ocular applications, cardiovascular applications, coronary stents, angioplasty balloons, contraceptive devices, cell culture, hernia mesh, gynecological applications, or urology applications.

Furthermore by utilising dip/spray coating techniques, devices such as tubular devices, or concerting devices (for use as vascular prostheses) may be formed.

Preferred features and embodiments of each aspect of the invention are as for each of the other aspects mutatis mutandis unless context demands otherwise.

Embodiments of the present invention will now be described, by way of example only, with reference to the accompanying figures.

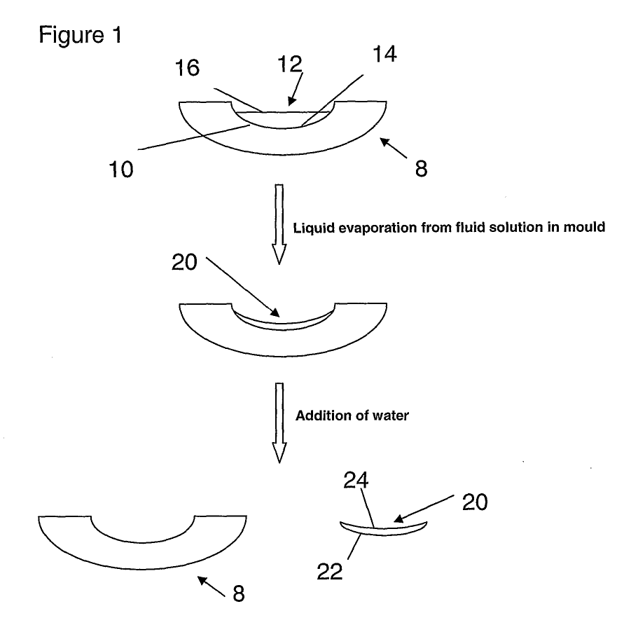

FIG. 1 is an illustration of a method of the present invention for forming a contact lens wherein the mould surface has a high surface energy, for example wherein the mould surface is steel;

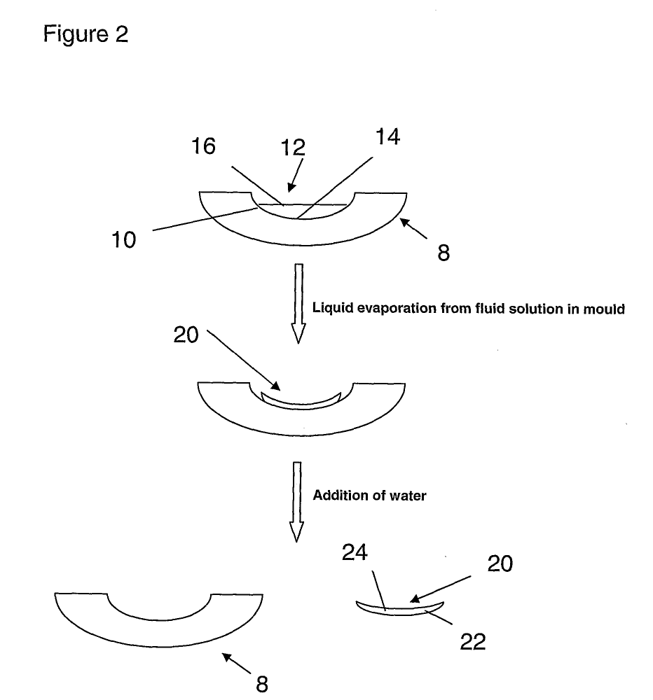

FIG. 2 is an illustration of a method of the present invention for forming a contact lens wherein the mould surface has a low surface energy, for example wherein the mould surface is polypropylene or PTFE; and

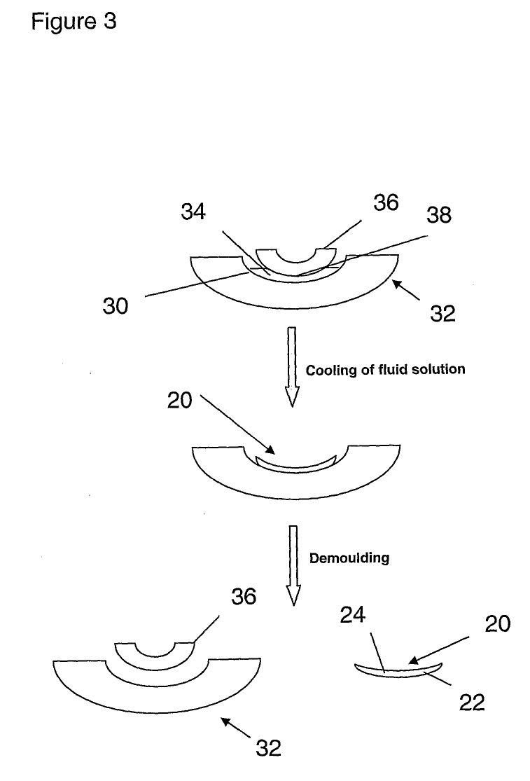

FIG. 3 is an illustration of a method of the present invention for forming a contact lens using a conventional two part mould.

As illustrated in FIG. 1, in a particular embodiment of the method of the invention there is provided a method for forming a contact lens 20. In this embodiment of the method the mould surface of the mould 8 to which the fluid solution is applied is provided by a bottom surface 10 of a receptacle. The bottom surface is curved. The bottom curved mould surface of the receptacle shapes the outer anterior convex surface 22 of the contact lens 20. In use, the anterior convex surface of the lens comes into contact with and forms the pre corneal tear film.

In this embodiment, the step of removing the solvent from the fluid solution or of polymer is performed using evaporation.

The evaporation of solvent from the fluid solution or of polymer applied to the mould surface and held by the receptacle affords the inner, concave, posterior surface of the lens, which, in use, contacts the cornea and conjunctiva of the eye.

As illustrated in FIG. 3, a fluid solution comprising non-macrogelled polymer and dispersion agent is provided into a two part mould which provides two mould surfaces. The mould surface 30 of the female mould 32 which is shaped to receive the fluid solution 34 is curved. The curved mould surface of the female mould shapes the outer anterior convex surface 22 of the contact lens 20. In use, the anterior convex surface of the lens comes into contact with and forms the pre corneal tear film.

The inner, concave, posterior surface of the lens, which, in use, contacts the cornea and conjunctiva of the eye is formed by a second mould surface 36. In the method the fluid solution is provided between the two mould surfaces and the temperature of the fluid solution is reduced to gel the fluid solution into a polymeric device as defined by the first and second mould surfaces. This technique is advantageous as it uses conventional moulds, but the use of a non-macrogelled fluid solution minimises shrinkage of the polymeric device in the mould.

Suitable non-macrogelled polymers for use in the method of the present invention may be provided as disclosed by WO 91/02763, WO94/22934 or WO 2004/020495.

Linear Thermoplastic Poly Urethane/Urea (PUU) Polymeric Material Using an Aromatic Diamine

### Example 1

A non-macrogelled polymer was prepared using the following method. Polypropylene glycol 425 (PPG 425) (27.1565 g) and anhydrous ferric chloride (0.0112 g) were weighed into a beaker that was placed in an oven at 95° C. The ferric chloride dissolved within a few minutes by the aid of stirring by a glass rod and 4,4′-methylenedianiline (DPDA) (0.3167 g) was added, thoroughly stirred and the beaker was replaced in the oven.

Then molten polyethylene glycol 3130 (PEG 3130) (10.00 g) was added to the same beaker, stirred and the beaker was replaced in the oven for 15 minutes. During this period the contents were occasionally stirred to ensure thorough mixing.

Finally Desmodur W (biscyclohexylmethane-4,4′-diisocyanate) (18.9327 g) was added while the contents of the beaker were being stirred and the beaker was replaced in the oven for few minutes where the contents were occasionally stirred. The contents of this beaker were then poured into preheated (to 95° C.) polypropylene moulds and these moulds were replaced in the oven at 95° C. and allowed to cure until completion. The solid product was allowed to cool to ambient temperature and readily demoulded by further quenching.

As will be understood by those of skill in the art, suitable non-macrogelled polymer compositions may include PPG 425, ferric chloride, DPDA, PEG 5950 and Desmodur W; 1,2,6-hexanetriol (HT), PPG, anhydrous ferric chloride, ferric chloride, PEG 3880, BHA and Desmodur W; and 1,2,6-hexanetriol (HT), PPG 430, anhydrous ferric chloride, PEG, 2,3-tert-butyl-4-methoxyphenol (BHA) and Desmodur W.

The following method was used to form lens like objects from a range of non macrogelled hydrogel polyethylene oxide based polymers.

Forming Fluid Solution of Non-Macrogelled Agent in a Dispersion Agent

A non macrogelled hydrogel PEG based polymer composition was solvated in methanol to afford an approximate 10% w/w fluid solution 12.

100 microlitres of this polymer solution was poured into a female mould 8, whereby one surface of the fluid solution 14 was in contact with the mould 10 and the other surface of the fluid solution (the non-mould contact surface) 16 was free from the mould contact and exposed. The solvent was evaporated from the polymer solution in the mould over a period of up to around 2 hours at ambient temperature. The fluid solution of polymer formed a curved surface device 20, shaped like a contact lens, in which a curved surface 24 was provided wherein said curved surface was not in contact with the mould surface. Water was added to the mould which exchanged with any remaining solvent remaining in the device and the optically transparent lens like object was separated from the mould. As discussed, herein various demoulding techniques may be applied to aid demoulding of the polymeric device from the mould.

In an alternative embodiment, as discussed above and illustrated in FIG. 3, a two part mould or conventional lens mould with two lens forming surfaces 30 and 38 may be used in the method of the present invention wherein the fluid solution 34 may be suitable gelled between the moulds such that the lens forming surfaces of the mould provide the front 22 and back 24 surfaces of the lens 20.

The water exchanges with and replaces the dispersing agent and also causes a promotion of the intermolecular associations which cause the gelation to a swollen shape retaining mass.

The method of the illustrated embodiment is advantageous to provide polymeric devices shaped like soft contact lenses, as it results in the formation of a lens shape without the need of a second mould. Currently, conventional manufacturing processes typically require a second mould portion to complete the mould and provide an enclosed space for polymerisation to occur and to form the inner surface of the lens. Further, in contrast to conventional contact lens and refractive device manufacturing techniques, in the present method further polymerisation of the polymer(s) is not required. This reduces lens production time and reduces inter batch variability.

In addition, in combination with flow effects and gravity, curved or bicurved devices with desirably or naturally rounded edge profiles around the moulded device circumference may be provided. These edges may be further modified by use of mechanical cutting or machining, or by solvents, washing or heating, or by modifying the mould material or surface coating of the mould. Optimisation of the edge profile of bicurve devices for vision correction has significant clinical advantages, for example, the comfort and wear time of contact lenses is significantly effected by the lens edge profile. Similarly it is believed that the edge profile of intra ocular lenses has a significant effect on secondary cataract formation, which is a costly and significant clinical problem with intra ocular lenses.

Using a 10% w/w polymer in the fluid solution or (within the range 2 to 90%) is advantageous to use in the production of contact lenses as such concentration provides contact lenses with suitable characteristics.

Materials that are thermoplastic and able to be formed into lenses in the mobile dry state typically form lenses of much greater clarity after dissolution in appropriate solvents/solvent mixtures using the method of the present invention.

The polymeric devices formed by the methods of the invention typically are consistent because they are made from completely preformed polymer and do not require subsequent polymerisation. Thus, advantageously lenses and other ocular devices made by the process of the invention may have improved clarity.

Various modifications may be made to the invention herein described, without departing from the scope thereof. For example, in alternative embodiments, spin casting techniques may be used to provide an appropriate curved surface. In such an embodiment, a fluid solution containing the required volume of the polymer solution is allowed to rotate at an appropriate speed to make a lens shaped like device. In such embodiments, solvent evaporation can occur during the rotational mode and the curved surface can be exposed to a jet of steam that affords a contact lens like device that can be demoulded from the substrate by the usual methods described herein.

1. A method of forming a contact lens having a polymeric structure, wherein said contact lens has at least one curved surface, comprising the steps:
providing a fluid solution comprising a non-macrogelled polymer and a dispersion agent;
applying the fluid solution to at least one receiving surface of a mould, the receiving surface(s) of the mould being shaped to receive said fluid solution; and
allowing the formation of the device, by gelation, by at least one step selected from:
i) removing at least part of the dispersion agent from the fluid solution,
ii) modulating the temperature of the fluid solution,
iii) modulating at least one of the shear and vibrational state of the fluid solution,
iv) modulating the pH of the fluid solution, and
v) adding a non-solvent for the non-macrogelled polymer which is a swelling agent for the non-macrogelled polymer.

2. The method of claim 1 comprising the steps:
providing a fluid solution comprising a non-macrogelled polymer and a dispersion agent;
applying the fluid solution to a receiving surface of a mould, the receiving surface of the mould being shaped to receive said fluid solution, such that the fluid solution has at least one non-mould contact surface not in contact with the mould; and
allowing the formation of the device, by gelation, and forming a curved surface of at least one non-mould contact surface of the fluid solution by at least one step selected from;
i) removing at least part of the dispersion agent from the fluid solution,
ii) modulating the temperature of the fluid solution,
iii) modulating at least one of the shear and vibrational state of the fluid solution,
iv) modulating the pH of the fluid solution, and
v) adding a non-solvent for the non-macrogelled polymer which is a swelling agent for the non-macrogelled polymer.

3. The method of claim 2, wherein the curvature of the contact lens is further modulated by at least one of
i) applying centrifugal force to the fluid solution, and
ii) modulating air pressure or air flow at a non-mould contact surface of the fluid solution.

4. (canceled)

5. The method of claim 1 wherein said non-macrogelled polymer or polymers comprises at least one structural feature which provides for at least one of solvent, heat, pH and shear reversible interchain bonding selected from at least one of: microscopic phase separation, hydrogen bonding, polar bonding, π bonding, hydrophobic bonding, electrostatic bonding and ionic bonding.

6. (canceled)

7. The method of claim 1 wherein said non-macrogelled polymer includes moieties of units selected from at least one of polystyrene, polyhydrocarbon, polyalkyleneoxide, polyoxyalkylene oxide, polyester, polyamide, polyurethane, polyhydroxyalkyl methacrylate, polyalkyl methacrylate, polyvinylpyrrolidine, polyacrylic acid, polymethacrylic acid, polyalkylacrylate, polyhydroxy alkylacrylate, polyacrylamide, polymethacrylamide, polyurea, polypropylene oxide and polyurethaneurea.

8. (canceled)

9. The method of claim 1 wherein the polymer is a polyethylene oxide based co-polymer blended with branched, linear, nanoparticles or microparticles of hydrogel forming polymer.

10. The method of claim 9 wherein said hydrogel forming polymer comprises: polymer or copolymers of acrylates or methacrylates including alkyl acrylate, hydroxyalkylacrylate, aryl acrylate, alkacrylate, aryl methacrylate, hydroxyl alkyl methacrylate, alkyl methacrylate, acrylamide, acrylic acid, methacrylic acid, alkacrylamide; n-vinyl lactam; ethylenically unsaturated zwitterions; silicone; peptide(s); protein(s); natural polyacid(s); polyamine(s); polyamide(s); polysaccharide(s); starch(es); polyethylene glycol(s) or copolymers.

11-12. (canceled)

13. The method of claim 1 wherein the dispersion agent is selected from:
i) a non-volatile, non-polymerisable bulking agent capable of forming hydrophilic bonds,
ii) a low volatile, non-polymerisable bulking agent capable of forming hydrophilic bonds,
iii) a non-volatile diluent capable of forming hydrophilic bonds,
iv) a low volatile diluent capable of forming hydrophilic bonds,
v) a solvent or solvent mixture in which the polymer is soluble, or
vi) a water compatible bulking agent.

14. The method of claim 1 wherein the dispersion agent is at least one hydrophilic solvent selected from mono or poly alcohol(s), mono or polyester(s), mono or poly ketone(s), aliphatic or aromatic hydrocarbon(s), monoether(s) or polyether(s), cyclic monoether(s) or cyclic polyether(s).

15. (canceled)

16. The method of claim 1 wherein said method further comprises a step of exposing the formed polymeric device to a hydrophilic non-solvent for the polymer, wherein the hydrophilic non-solvent is in a liquid or vapour state.

17. (canceled)

18. The method of claim 1 further comprising at least one step selected from:
i) reacting the residual groups of the non-macrogelled polymer,
ii) spinning or rotating of the non-macrogelled polymer,
iii) applying mechanical assistance to shape the non-macrogelled polymer,
iv) modulating the airflow around the non-macrogelled polymer,
v) modulating the temperature around non-macrogelled polymer,
vi) modulating the pH of the fluid solution, and
vii) spraying.

19. The method of claim 1 wherein the method further comprises a demoulding step to separate the polymeric device from the mould selected from at least one of:
i) hydration of the polymeric device,
ii) temperature cycling of the polymeric device, and
iii) incorporation of mould release agents within the fluid solution.

20. (canceled)

21. The method claim 1 wherein said fluid solution comprises at least one of an additive and an active agent, wherein said active agent is selected from at least one of a processing aid, a prophylactic and/or a therapeutic agent, a pharmaceutically acceptable surface modifying agent, a pharmaceutical agent, a biologically active molecule, a light and/or chemical and/or electrically responsive agent, a colourant, a fluorescing or phosphorescing agent, a UV absorber, a polarising agent, a photochromic agent and an antioxidant.

22. (canceled)

23. The method of claim 1 wherein the method comprises at least one further step of modifying a surface of the contact lens selected from:
i) further moulding of the surface,
ii) adhering an agent or additive to the surface,
iii) etching the surface and,
iv) punching the surface, and
v) flash removal.

24. The method of claim 1 wherein the method further comprises the steps:
applying a further fluid solution of a polymer to at least one surface of the previously applied fluid solution, wherein said surface is at least partially gelled,
gelling the further fluid solution wherein the method of gelation is at least one step selected from:
i) removing at least part of the dispersion agent from the fluid solution,
ii) modulating the temperature of the fluid solution,
iii) modulating at least one of the shear and vibrational state of the fluid solution,
iv) modulating the pH of the fluid solution, and
v) adding a non-solvent for the non-macrogelled polymer which is a swelling agent for the non-macrogelled polymer, and
forming at least a second layer of gelled polymer,
to form a layered contact lens.

25-32. (canceled)
